(19) United States
(12) Patent Application Publication
(10) Pub. No.: US 2023/0110499 A1
(43) Pub. Date: Apr. 13, 2023

(54) ADDRESS SOLVING FOR INSTRUCTION SEQUENCE GENERATION

(71) Applicant: Huawei Technologies Co., Ltd., Shenzhen (CN)

(72) Inventors: Jingliang Wang, Austin, TX (US); Noah Lewis Sherrill, Austin, TX (US)

(21) Appl. No.: 18/074,140

(22) Filed: Dec. 2, 2022

Related U.S. Application Data
(63) Continuation of application No. PCT/US2021/016422, filed on Feb. 3, 2021.
(60) Provisional application No. 63/034,781, filed on Jun. 4, 2020.

(51) Int. Cl. G06F 3/06

(52) U.S. Cl. CPC G06F 3/0619; G06F 3/0653; G06F 3/0673

(57) ABSTRACT

A method and a network device for generating a memory access instruction are presented. The method includes obtaining constraints on a memory access instruction, the constraints comprising a target address range and a specification of valid address locations; obtaining simulation state information relating to a current state of a central processing unit (CPU) design simulation; and generating the memory access instruction based on the target address range, the specification of valid address locations, and the simulation state information.

### CROSS-REFERENCE TO RELATED APPLICATIONS

This application is a continuation of International Application No. PCT/US2021/016422 filed on Feb. 3, 2021, by Futurewei Technologies, Inc., and titled “Address Solving for Instruction Sequence Generation,” which claims priority to U.S. Provisional Pat. Application No. 63/034,781, filed Jun. 4, 2020, by Jingliang Wang, et al., and titled “Address Solving for Instruction Sequence Generation,” both of which are incorporated herein by reference.

### TECHNICAL FIELD

The present application relates to central processing unit (CPU) simulation, and more specifically to address solving methods for instruction sequence generation.

### BACKGROUND

Functional verification of a CPU design attempts to verify that the logic design of the CPU conforms to its specification. Such functional verification is complex because a large number of test cases are needed to increase assurance that the design conforms to its specification. For CPU design verification, such test cases include streams of instructions to be executed by a simulated CPU design in a design simulation system.

### SUMMARY

A first aspect relates to a method for generating a memory access instruction by a network device. The method includes obtaining constraints on a memory access instruction, the constraints comprising a target address range and a specification of valid address locations; obtaining simulation state information relating to a current state of a central processing unit (CPU) design simulation; and generating the memory access instruction based on the target address range, the specification of valid address locations, and the simulation state information.

Optionally, in any of the preceding aspects, another implementation of the aspect provides that generating the memory access instruction includes storing a value in a previously unused memory location of the CPU design simulation; and generating the memory access instruction further based on an address of the previously unused memory location.

Optionally, in any of the preceding aspects, another implementation of the aspect provides that generating the memory access instruction includes obtaining previous instruction information relating to a history of instructions previously simulated by the CPU design simulation; and generating the memory access instruction further based on the previous instruction information.

Optionally, in any of the preceding aspects, another implementation of the aspect provides that generating the memory access instruction includes generating a plurality of possible target addresses; and randomly selecting one of the possible target addresses for the memory access instruction.

Optionally, in any of the preceding aspects, another implementation of the aspect provides that generating the plurality of possible memory access instructions includes determining an instruction addressing mode of the memory access instruction; determining whether the instruction addressing mode permits combinations of fixed-value operands; determining whether the instruction addressing mode permits combinations of flexible-value operands; and for each combination of permitted fixed-value operands and/or flexible-value operands, combining the specification of valid address locations, the target address range, and the combination of permitted fixed-value operands and/or flexible-value operands to generate one possible memory access instruction of the plurality of possible memory access instructions.

Optionally, in any of the preceding aspects, another implementation of the aspect provides that the method further includes removing one or more memory access instructions from the plurality of memory access instructions based on a filter criterion prior to randomly selecting one memory access instruction of the plurality of memory access instructions.

Optionally, in any of the preceding aspects, another implementation of the aspect provides that the filter criterion is based on the previous instruction information.

Optionally, in any of the preceding aspects, another implementation of the aspect provides that the filter criterion is based on the simulation state information.

Optionally, in any of the preceding aspects, another implementation of the aspect provides that the network device is configured as an instruction stream generator (ISG), the method performed by the ISG.

Optionally, in any of the preceding aspects, another implementation of the aspect provides that the method further includes sending to the CPU design simulation environment, an executable test case including the memory access instruction.

A second aspect relates to a network device that includes a memory configured to store instructions; and a processor coupled to the memory and configured to execute the instructions stored in the memory. When executed by the processor, the instructions cause the network device to obtain constraints on a memory access instruction, the constraints comprising a target address range and a specification of valid address locations; obtain simulation state information relating to a current state of a central processing unit (CPU) design simulation; and generate the memory access instruction based on the target address range, the specification of valid address locations, and the simulation state information.

Optionally, in any of the preceding aspects, another implementation of the aspect provides that executing the instructions further causes the network device to store a value in a previously unused memory location of the CPU design simulation; and generate the memory access instruction further based on an address of the previously unused memory location.

Optionally, in any of the preceding aspects, another implementation of the aspect provides that executing the instructions further causes the network device to obtain previous instruction information relating to a history of instructions previously simulated by the CPU design simulation; and generate the memory access instruction further based on the previous instruction information.

Optionally, in any of the preceding aspects, another implementation of the aspect provides that executing the instructions further causes the network device to generate a plurality of possible target addresses; and randomly select one of the possible target addresses for the memory access instruction.

Optionally, in any of the preceding aspects, another implementation of the aspect provides that executing the instructions further causes the network device to determine an instruction addressing mode of the memory access instruction; determine whether the instruction addressing mode permits combinations of fixed-value operands; determine whether the instruction addressing mode permits combinations of flexible-value operands; and for each combination of permitted fixed-value operands and/or flexible-value operands, combine the specification of valid address locations, the target address range, and the combination of permitted fixed-value operands and/or flexible-value operands to generate one possible memory access instruction of the plurality of possible memory access instructions.

Optionally, in any of the preceding aspects, another implementation of the aspect provides that executing the instructions further causes the network device to remove one or more memory access instructions from the plurality of memory access instructions based on a filter criterion prior to randomly selecting one memory access instruction of the plurality of memory access instructions.

Optionally, in any of the preceding aspects, another implementation of the aspect provides that the filter criterion is based on the previous instruction information.

Optionally, in any of the preceding aspects, another implementation of the aspect provides that the filter criterion is based on the simulation state information.

Optionally, in any of the preceding aspects, another implementation of the aspect provides that the instructions comprise an instruction stream generator.

Optionally, in any of the preceding aspects, another implementation of the aspect provides that executing the instructions further causes the network device to send to the CPU design simulation environment, an executable test case including the memory access instruction.

For the purpose of clarity, any one of the foregoing embodiments may be combined with any one or more of the other foregoing embodiments to create a new embodiment within the scope of the present disclosure.

These and other features, and the advantages thereof, will be more clearly understood from the following detailed description taken in conjunction with the accompanying drawings and claims.

### BRIEF DESCRIPTION OF THE DRAWINGS

For a more complete understanding of this disclosure, reference is now made to the following brief description, taken in connection with the accompanying drawings and detailed description, wherein like reference numerals represent like parts.

FIG. 1 presents a block diagram of a CPU design simulation system according to the embodiment.

FIG. 2 presents a block diagram of an instruction stream generator (ISG) address solver module (ASM) according to the embodiment for generating a memory access instruction.

FIG. 3 presents a flow chart of a first method of an ASM according to the embodiment for generating a target address solution.

FIG. 4 presents a flow chart of a second method of an ASM according to the embodiment for generating a target address solution.

FIG. 5 presents a flow chart of a third method of an ASM according to the embodiment for generating a target address solution.

FIG. 6 presents an execution diagram of an ISG according to the embodiment.

FIG. 7 is a schematic diagram illustrating a network device according to an embodiment of the present disclosure.

FIG. 8 illustrates an apparatus configured to implement one or more of the methods described herein for implementing an ASM according to the embodiment.

### DETAILED DESCRIPTION

It should be understood at the outset that, although illustrative implementations of one or more embodiments are provided below, the disclosed systems and/or methods may be implemented using any number of techniques, whether currently known or in existence. The disclosure should in no way be limited to the illustrative implementations, drawings, and techniques illustrated below, including the exemplary designs and implementations illustrated and described herein, but may be modified within the scope of the appended claims along with their full scope of equivalents.

A design simulation system according to the disclosure includes an instruction stream generator (ISG) that generates streams of instructions that test various functions of a CPU design being simulated by the design simulation system. One function of the ISG is to generate memory access instructions. An ISG may generate memory access patterns randomly or under limited constraints.

An ISG having an ASM according to the disclosure may create testing scenarios that deliberately stress the CPU design with memory access patterns that target page boundaries or cache lines, for example. An ASM according to the disclosure instead creates memory access patterns based on constraints that include a target address range, a specification of valid address locations, and simulation state information relating to a current state of the CPU design simulation environment. Such an ASM results in an ISG that provides improved testing quality of memory access instructions that can meet any of several goals:
1. The memory access instructions might cause no exceptions, so that the simulation will focus on continued instruction flow through the pipeline with the interaction of instruction sequence without the disturbance of exceptions.
2. The memory access instructions might cause specific exceptions, but not other exceptions, to direct the focus of testing the CPU design’s correct behavior in the context of those specific exceptions.
3. The memory access instructions might cause a desired number of exceptions of various desired types so as to test the CPU design’s correct behavior in the context of heavy exception occurrences.
In this way, an ASM according to the disclosure able to provide controls to allow these desired scenarios to happen by generating memory access instructions according to appropriate constraints that produce addresses meeting the requirements of the constraints. In this context, a valid address is one that meets the requirements of the constraints.

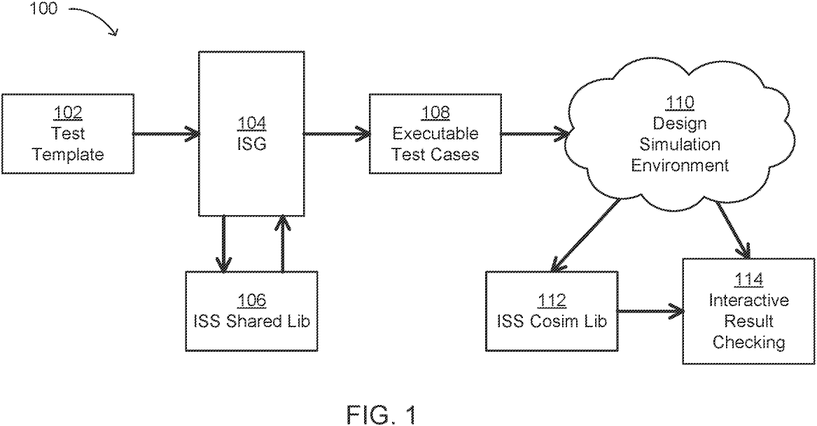

FIG. 1 presents a block diagram of a CPU design simulation system 100 according to the embodiment. An ISG 104 (which may also be referred to as an instruction sequence generator) receives one or more test templates 102 from a user of the ISG 104. The test templates 102 describe instructions to be generated by the ISG 104. In some embodiments, the ISG 104 is an open FORCE-RISCV ISG. RISCV indicates that a reduced instruction set computer (RISC) using RISC-V instruction set architecture (ISA) is being simulated by the CPU design simulation system 100. The ISG 104 uses an instruction set architecture simulator (ISS) shared library 106 of code segments to cause a CPU design simulation environment (DSE) 110 to change its state and to simulate individual instructions generated by the ISG 104. Instruction sequences generated by the ISG 104 are subsequently collected and combined with a data section in forming executable test cases 108 that are executed by the DSE 110 using an ISS cosimulation library 112. As the DSE 110 produces simulation results (or test run results) a user of the DSE 110 performs an interactive result checking process 114 on the results, also using the ISS cosimulation library 112.

At least the ISG 104, the ISS shared library 106, the DSE 110, and the ISS cosimulation library 112 are software comprising instructions stored in memory of a computing device and executed by a processor of the computing device. Typically, the CPU design simulation system 100 is implemented on multiple computing devices interconnected by a communication network using an Ethernet network and/or the Internet protocol. Such computing devices may be referred to as network devices. In some embodiments, the ISG 104 and the ISS shared library 106 may be implemented in software on a first network device. In such embodiments, the test templates 102 may be generated on the same network device, or may be received by that network device from another network device. In such embodiments, the DSE 110 and the ISS cosimulation library 112 may be implemented on one or more other network devices. In other embodiments, a smaller-scale CPU design simulation system 100 may be implemented on a single network device.

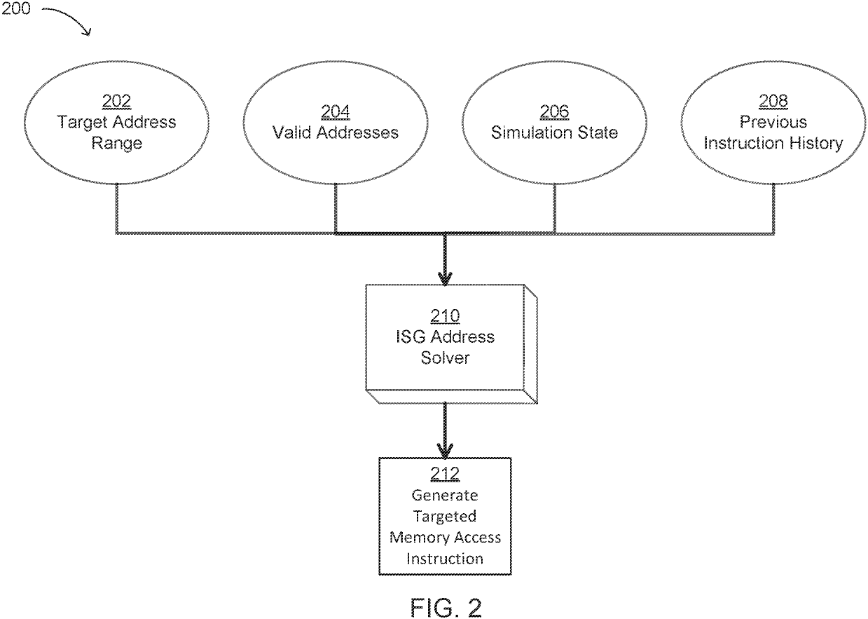

FIG. 2 presents a block diagram 200 of an instruction stream generator (ISG) address solver module (ASM) 210 according to the embodiment for generating a memory access instruction. The ASM 210 obtains constraints on one or more target address ranges 202 and one or more specifications of valid addresses 204. The ASM 210 also obtains simulation state information 206 relating to a current state of the DSE 110. The ASM 210 may also obtain previous instruction history information 208 relating to previous instructions generated by the ISG 104 and simulated using the ISS shared library 106. From these constraints and information, the ASM 210 generates one or more target addresses that are used by the ISG 104 in step 212 to generate one or more memory access instructions.

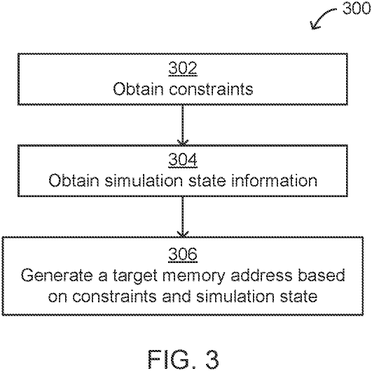

FIG. 3 presents a flow chart of a first method 300 of an ASM according to the embodiment for generating a target address solution. The target address solution may include a memory address and the operand values required for the instruction to access the target memory address. The target address solution may also include initial values for uninitialized registers used as operands for the instruction. In step 302, the ASM 210 obtains one or more constraints on the target address solution. As described with reference to FIG. 2, such constraints may include one or more target address ranges 202 and one or more specifications of valid addresses 204. In step 304, the ASM 210 obtains the simulation state information 206 and may also obtain the previous instruction history information 208. In both steps 302 and 304, the ASM 210 may obtain the constraints and information via any combination of one or more channels: direct input from a user of the CPU design simulation system 100, receiving one or more test templates 102, receiving or requesting data from the ISS shared library 106 or the DSE 110, or receiving or requesting data from any other of the network devices of the CPU design simulation system 100. In step 306, the ASM 210 generates the target address solution based on one or more of the constraints and information obtained in steps 302 and 304.

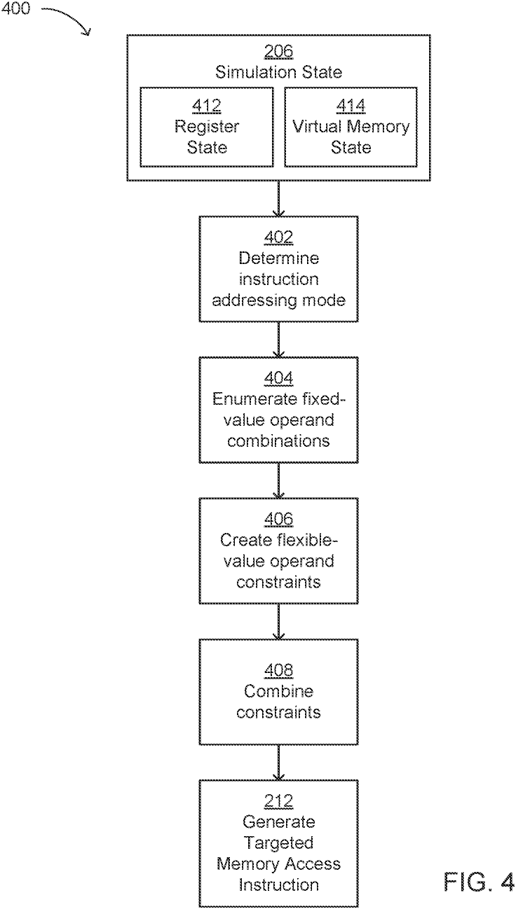

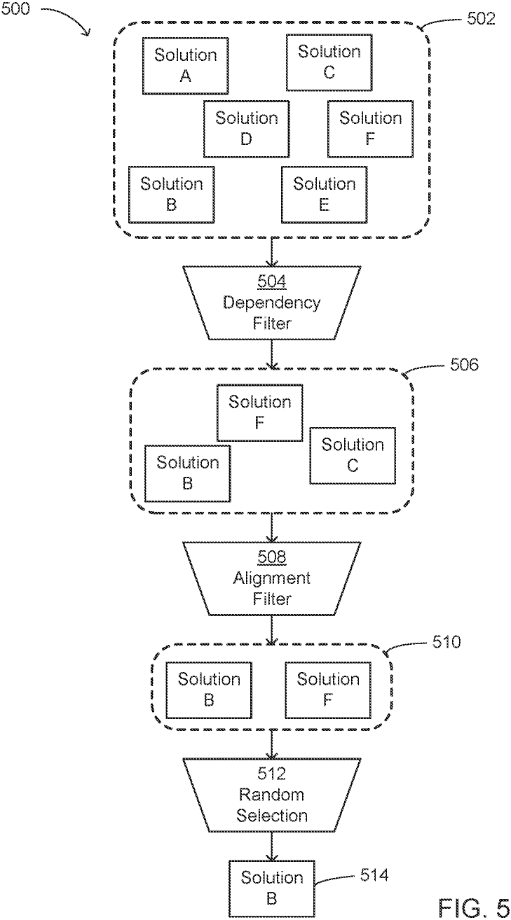

As will be explained in greater detail with reference to FIGS. 4 and 5, some embodiments of the method 300 may provide for randomness in the target address solution generation of step 306, while still conforming to the constraints obtained in step 302 and being based on the information obtained in step 304. As a result, in such embodiments, a second application of the method 300 may result in a different target address solution than a first application of the method 300, even with the same constraints and information obtained in steps 302 and 304.

In some such embodiments, the method 300 generates a plurality of target address solutions from the constraints and information obtained in steps 302 and 304 and, because of the randomness discussed above, the plurality of target address solutions may not be identical. In other embodiments, the ISG 104 applies the method 300 repeatedly, either with the same or different constraints and information, to generate a plurality of target address solutions.

FIG. 4 presents a flow chart of a second method 400 of an ASM according to the embodiment for generating a target address solution. In step 402, the ASM 210 determines an address computation mechanism or addressing mode for a memory access instruction. In step 404, the ASM 210 determines whether the addressing mode permits combinations of register operands or other fixed-value operands and enumerates operand value-related constraints based on the combinations of fixed-value operands. Examples of fixed-value operands that are register operands include register contents and register identifiers.

In step 406, the ASM 210 determines, for each operand value-related constraint, whether the addressing mode permits combinations of flexible-value operands and, if permitted, adds to the operand value-related constraint one or more additional constraints based on the combinations of flexible-value operands. Examples of flexible-value operands include immediate operands and enumerated operands, which have a small set of valid encoding values (e.g., a binary flag). In step 408, the ASM 210 combines the operand value-related constraints with further constraints based on the target address range(s) 202 and the valid addresses 204. Step 408 may further constrain the operand value-related constraints based on a virtual memory model maintained within the ISG 104 that is used to determine valid memory address locations.

One or more possible target addresses for the memory access instruction of step 402 result from step 408 and are used in step 212 to generate one or more of the memory access instructions. As described with reference to FIG. 3, random selection may be used to select from the one or more target addresses for use in generating the one or more memory access instructions or to select from the one or more memory access instructions. As is described below with reference to FIG. 5, filters may be used to remove one or more of the target addresses before generating the one or more memory access instructions.

FIG. 5 presents a flow chart of a third method 500 of an ASM according to the embodiment for generating a target address solution. As described with reference to FIGS. 3 and 4, an ASM according to the embodiment may generate a plurality of target address solutions 502. The method 500 applies one or more filters to remove one or more of the plurality of target address solutions 502. The filters may be based on the previous instruction history information 208 or on the simulation state information 206, such as register state 412 and/or virtual memory state 414.

In step 504, the plurality of target address solutions 502 is reduced to a second plurality of target address solutions 506 by a dependency filter. One example of a dependency filter is a filter that removes any target address solution that does not include a register index that was used in a previous simulated instruction, as reflected in the previous instruction history information 208. Another example of a dependency filter is to retain target address solutions that include a register index that was written to in one of the previous simulated instructions within a window of previous instructions that is proportional to the pipeline depth. In the example of the method 500 shown in FIG. 5, step 504 reduces the six target address solutions 502 to the three target address solutions 506 by applying the dependency filter.

In step 508, the second plurality of target address solutions 506 is reduced to a third plurality of target address solutions 510 by applying an alignment filter. One example of an alignment filter is a filter that removes any target address solution that includes a stack pointer that does not align with a current stack base, as reflected in the simulation state information 206.

The addressing mode for a memory access instruction may not be suitable for application of either or both of the dependency filters and alignment filters described above. Some addressing modes may be suitable for application of another type of either dependency filter or alignment filter. Still other addressing modes may be suitable for application of another type of filter than a dependency filter or alignment filter. Regardless, the method 500 provides for reducing the plurality of target address solutions 502 by removing target address solutions that satisfy the constraints and information used in the method 300 or the method 400, but not additional dependency, alignment, or other filters.

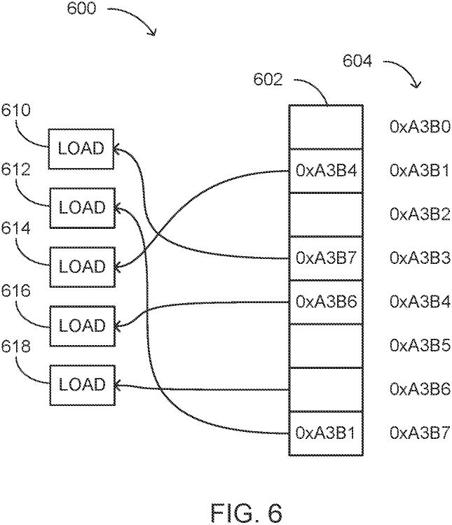

FIG. 6 presents an execution diagram 600 of an ISG according to the embodiment. A memory simulated by the DSE 110 includes memory locations 602 having respective addresses 604. Prior to generating LOAD instruction 610, the ISG 104 uses the ISS shared library 106 to store the value 0xA3B7 in the memory location 602 at address 0xA3B3. The ISG 104 then generates the LOAD instruction 610 with the address 0xA3B3 as its target memory address. When the LOAD instruction 610 is simulated by the DSE 110, the value that is read from the memory 602 is compared to the stored value to confirm that the LOAD instruction 610 was correctly performed by the memory simulated by the ISS cosimulation library 112. The address 0xA3B3 is selected as it is a previously unused memory location, thereby avoiding interfering with another aspect of the operation of the ISG 104.

Where the value 0xA3B7 is confirmed as correctly read in LOAD instruction 610, the ISG 104 confirms that the memory at address 0xA3B7 is previously unused and stores therein the value 0xA3B1. The ISG 104 then generates LOAD instruction 612 with the address 0xA3B7 as its target memory address. When the LOAD instruction 612 is simulated, the value that is read from the memory 602 is compared to the stored value 0xA3B7. In a similar manner, LOAD instructions 614, 616, and 618 are generated with target memory addresses of previously unused memory locations 602 to which known values have been stored.

Such preloading of values into selected locations in memory may be performed in an executable test case 108 by the ISG 104 writing the memory values to the data section of the Executable Test Case. When the DSE 110 reads the executable test case 108, it loads these memory values into its memory model.

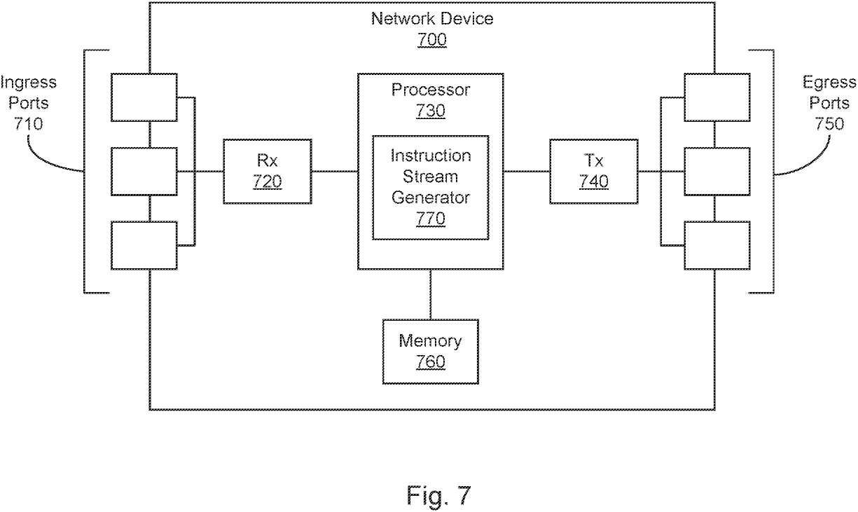

FIG. 7 is a schematic diagram illustrating a network device 700 according to an embodiment of the present disclosure. The network device 700 includes receiver units (RX) 720 or receiving means for receiving data via ingress ports 710. The network device 700 also includes transmitter units (TX) 740 or transmitting means for transmitting via data egress ports 750.

The network device 700 includes a memory 760 or data storing means configured to store the instructions and various data. The memory 760 can be any type of or combination of memory components capable of storing data and/or instructions. For example, the memory 760 can include volatile and/or non-volatile memory such as read-only memory (ROM), random access memory (RAM), ternary content-addressable memory (TCAM), and/or static random-access memory (SRAM). The memory 760 can also include one or more disks, tape drives, and solid-state drives. In some embodiments, the memory 760 can be used as an over-flow data storage device to store programs when such programs are selected for execution, and to store instructions and data that are read during program execution.

The network device 700 has one or more processor(s) 730 or other processing means (e.g., central processing unit (CPU)) to process instructions. The processor 730 may be implemented as one or more CPU chips, cores (e.g., as a multi-core processor), field-programmable gate arrays (FPGAs), application specific integrated circuits (ASICs), and digital signal processors (DSPs). The processor 730 is communicatively coupled via a system bus with the ingress ports 710, RX 720, TX 740, egress ports 750, and memory 760. The processor 730 can be configured to execute instructions stored in the memory 760. Thus, the processor 730 provides a means for performing any computational, comparison, determination, initiation, configuration, or any other action corresponding to the claims when the appropriate instruction is executed by the processor. In some embodiments, the memory 760 can be memory that is integrated with the processor 730.

In one embodiment, the memory 760 stores an ISG 770. The ISG 770 includes data and executable instructions for implementing the disclosed embodiments. For instance, the ISG 770 can include instructions for implementing the methods described with reference to FIGS. 3-6. The inclusion of the ISG 770 substantially improves the functionality of the network device 700 by enabling an ISG according to the disclosure to generate memory access instructions that produce fewer unexpected simulation exceptions than randomly generated instructions and that provide improved testing quality of a CPU design simulation. A network device 700 including an ISG 770 that implements a first of the disclosed methods for generating a target address solution is a different system than a network device 700 that includes an ISG 770 that implements a second of the disclosed methods for generating a target address solution.

The network device 700 includes data and executable instructions for implementing an ISG as described in any of FIGS. 3-6. In other embodiments, the network device 700 may additionally implement other elements of the CPU design simulation system 100.

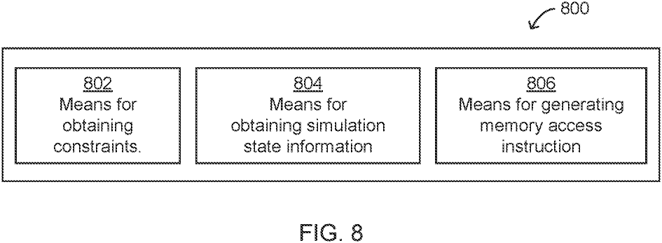

FIG. 8 illustrates an apparatus 800 configured to implement one or more of the methods described herein for generating a memory access instruction, such as, for example, the method 300 of FIG. 3, the method 400 of FIG. 4, or the method 500 of FIG. 5. The apparatus 800 may be implemented in the network device 700. The apparatus 800 comprises means 802 for obtaining one or more constraints on a target address solution, as described, for example, with reference to step 302 of the method 300. The apparatus 800 further comprises means 804 for obtaining simulation state information and, in some embodiments, previously simulated instruction history information, as described, for example, with reference to step 304 of the method 300. The apparatus 800 still further comprises means 806 for generating one or more target addresses and, from them, one or more memory access instructions, as described with reference to step 212 of the methods 200 and 400.

While several embodiments have been provided in the present disclosure, it may be understood that the disclosed systems and methods might be embodied in many other specific forms without departing from the spirit or scope of the present disclosure. The present examples are to be considered as illustrative and not restrictive, and the disclosure is not to be limited to the details given herein. For example, the various elements or components may be combined or integrated in another system or certain features may be omitted, or not implemented.

In addition, techniques, systems, subsystems, and methods described and illustrated in the various embodiments as discrete or separate may be combined or integrated with other systems, modules, techniques, or methods without departing from the scope of the present disclosure. Other items shown or discussed as coupled or directly coupled or communicating with each other may be indirectly coupled or communicating through some interface, device, or intermediate component whether electrically, mechanically, or otherwise. Other examples of changes, substitutions, and alterations are ascertainable by one skilled in the art and may be made without departing from the spirit and scope disclosed herein.

What is claimed is:

1. A method for generating a memory access instruction by a network device, the method comprising:
obtaining constraints on a memory access instruction, the constraints comprising a target address range and a specification of valid address locations;
obtaining simulation state information relating to a current state of a central processing unit (CPU) design simulation; and
generating the memory access instruction based on the target address range, the specification of valid address locations, and the simulation state information.

2. The method of claim 1, wherein the step of generating comprises:
storing a value in a previously unused memory location of the CPU design simulation; and
generating the memory access instruction further based on an address of the previously unused memory location.

3. The method of claim 2, wherein the step of storing is performed according to information stored in an executable test case.

4. The method of claim 1, wherein the step of generating comprises:
obtaining previous instruction information relating to a history of instructions previously simulated by the CPU design simulation; and
generating the memory access instruction further based on the previous instruction information.

5. A method for generating a memory access instruction by a network device, the method comprising:
obtaining constraints on a memory access instruction, the constraints comprising a target address range and a specification of valid address locations;
obtaining simulation state information relating to a current state of a central processing unit (CPU) design simulation;
generating a plurality of possible target addresses based on the target address range, the specification of valid address locations, and the simulation state information;
selecting one of the possible target addresses for the memory access instruction; and
generating the memory access instruction based on the selected one of the possible target addresses.

6. The method of claim 5 wherein the step of selecting includes randomly selecting the one of possible target address.

7. The method of claim 5 wherein the step of selecting includes selecting a previously unused memory location of the CPU design simulation.

8. The method of claim 5, wherein the step of generating the plurality of possible target addresses comprises:
determining an instruction addressing mode of the memory access instruction;
determining whether the instruction addressing mode permits combinations of fixed-value operands;
determining whether the instruction addressing mode permits combinations of flexible-value operands; and
for each combination of permitted fixed-value operands and/or flexible-value operands, combining the specification of valid address locations, the target address range, and the combination of permitted fixed-value operands and/or flexible-value operands to generate one possible target address of the plurality of possible target addresses.

9. The method of claim 5, further comprising, removing one or more possible target addresses from the plurality of possible target addresses based on a filter criterion prior to selecting one possible target address of the plurality of possible target addresses.

10. The method of claim 9, wherein the filter criterion is based on one of the simulation state information and previous instruction information relating to a history of instructions previously simulated by the CPU design simulation.

11. A network device, comprising:
a memory configured to store instructions; and
a processor coupled to the memory and configured to execute the instructions stored in the memory to cause the network device to:
obtain constraints on a memory access instruction, the constraints comprising a target address range and a specification of valid address locations;
obtain simulation state information relating to a current state of a central processing unit (CPU) design simulation; and
generate the memory access instruction based on the target address range, the specification of valid address locations, and the simulation state information.

12. The network device of claim 11, wherein executing the instructions further causes the network device to:
store a value in a previously unused memory location of the CPU design simulation; and
generate the memory access instruction further based on an address of the previously unused memory location.

13. The network device of claim 11, wherein executing the instructions further causes the network device to:
obtain previous instruction information relating to a history of instructions previously simulated by the CPU design simulation; and
generate the memory access instruction further based on the previous instruction information.

14. The network device of claim 11, wherein executing the instructions further causes the network device to:
generate a plurality of possible target addresses; and
randomly select one of the possible target addresses for the memory access instruction.

15. The network device of claim 14, wherein executing the instructions further causes the network device to:
determine an instruction addressing mode of the memory access instruction;
determine whether the instruction addressing mode permits combinations of fixed-value operands;
determine whether the instruction addressing mode permits combinations of flexible-value operands; and
for each combination of permitted fixed-value operands and/or flexible-value operands, combine the specification of valid address locations, the target address range, and the combination of permitted fixed-value operands and/or flexible-value operands to generate one possible target address of the plurality of possible target addresses.

16. The network device of claim 14, wherein executing the instructions further causes the network device to:
remove one or more possible target addresses from the plurality of possible target addresses based on a filter criterion prior to randomly selecting one possible target address of the plurality of possible target addresses.

17. The network device of claim 16, wherein executing the instructions further causes the network device to:
obtain previous instruction information relating to a history of instructions previously simulated by the CPU design simulation, wherein the filter criterion is based on the previous instruction information.

18. The network device of claim 16, wherein the filter criterion is based on the simulation state information.

19. The network device of claim 11, wherein the instructions comprise an instruction stream generator.

20. The network device of claim 11, wherein executing the instructions further causes the network device to:
send to the CPU design simulation, an executable test case including the memory access instruction.
